(19) United States
(12) Patent Application Publication
(10) Pub. No.: US 2025/0391214 A1
(43) Pub. Date: Dec. 25, 2025

(54) CONTEXT-TAGGED ACCESS CREDENTIALS FOR PHYSICAL ACCESS CONTROL

(71) Applicant: Google LLC, Mountain View, CA (US)

(72) Inventors: Ahmad Rahmati, Mountain View, CA (US); Amol Tuli, Dublin, CA (US)

(21) Appl. No.: 19/232,318

(22) Filed: Jun. 9, 2025

Related U.S. Application Data
(60) Provisional application No. 63/662,514, filed on Jun. 21, 2024.

(51) Int. Cl. G07C 9/20

(52) U.S. Cl. CPC G07C 9/20

(57) ABSTRACT

In one example, a method for context-tagging access credentials for physical access control includes receiving, by an access control device associated with a locking device for a controlled area and from a computing device, an access request including one or more access credentials and contextual information indicating one or more activities being performed by a user of the computing device, and determining, by the access control device, whether the contextual information satisfies one or more contextual conditions. The method may further include determining, by the access control device, whether the one or more access credentials are valid, and, responsive to determining that the one or more access credentials are valid and responsive to determining that the contextual information satisfies the one or more contextual conditions, changing, by the access control device, a state of the locking device.

### BACKGROUND

Access control readers may control access to physical areas by permitting or denying entry to the area. Access control readers may permit access by unlocking doors or other openings upon receipt of valid access credentials from digital key devices, such as mobile devices and wearable devices. When access credentials are invalid, access control readers may deny access by refraining from unlocking a locked door or other opening. Digital key devices and access control readers may communicate access credentials using various wireless communication protocols.

### SUMMARY

In general, techniques of this disclosure are directed to use of context-tagged access credentials for physical access control. In some examples, digital key devices (e.g., mobile devices or wearable devices) may provide access credentials tagged with contextual information to an access control device (e.g., access control reader). For instance, a digital key device may transmit access credentials along with contextual information to the access control device. The access control device may utilize the contextual information to refine a determination of whether to permit or deny physical access to an area.

Some access control readers determine to permit or deny physical access based on access credentials. In such systems, an access control reader may permit or deny physical access (e.g., unlock or lock, respectively) based only upon validating the access credentials. In some systems, a digital key device may determine the relevant access credentials to present to an access control reader based on an identifier of the access control reader, such as the group identification (group ID) or subgroup identification (subgroup ID) of the access control reader.

In accordance with the techniques disclosed herein, an access control device may determine whether to permit or deny physical access based on access credentials as well as contextual information indicating one or more activities being performed by a user. In this manner, the access control device may, for example, refrain from permitting access when the contextual information indicates access should not be permitted even when the access credentials are valid. For example, an access control device for an automobile or bicycle garage may refrain from permitting access when contextual information indicates the user of the digital key device is not in or on an automobile or bicycle.

In some examples, the digital key device may evaluate the contextual information and send the access credentials, without including or sending the contextual information, to the access control device. Continuing the above example for instance, the digital key device may locally determine that the user must be performing certain activities (e.g., be on an automobile or bicycle) to obtain access from the access control device. In such a case, assuming the user is performing these activities, the digital key device may send the access credentials, without the contextual conditions, to the access control device. In this manner, the contextual information may be retained by the digital key device and not shared with access control devices.

As can be seen, the contextual information may be beneficial to hands free access control where an access control device may automatically unlock without any additional user action. In accordance with the techniques disclosed herein for instance, an access control device for a pedestrian door may not unlock when the contextual information indicates the user is passing by in or on a vehicle (e.g., automobile or bicycle), or an access control device for an exterior door of a home may only unlock when the contextual information indicates the user is outside as opposed to inside the home. With respect to non-hands free operation, the techniques disclosed herein may cause the digital key device to refrain from prompting for user authorization or confirmation to unlock the access control device based on the contextual information. For example, the digital key device may refrain from prompting the user for confirmation to unlock an access control device for a garage door when the contextual information indicates the user is not in a vehicle or the user is on foot (e.g., walking or running).

In one example, various aspects of the techniques are directed to a method comprising: receiving, by an access control device associated with a locking device for a controlled area and from a computing device, an access request including one or more access credentials and contextual information indicating one or more activities being performed by a user of the computing device; determining, by the access control device, whether the contextual information satisfies one or more contextual conditions; determining, by the access control device, whether the one or more access credentials are valid; and responsive to determining that the one or more access credentials are valid and responsive to determining that the contextual information satisfies the one or more contextual conditions, changing, by the access control device, a state of the locking device.

In another example, various aspects of the techniques are directed to a computing device including a locking device for a controlled area, a memory that stores instructions, and processing circuitry that executes the instructions to: receive, from a computing device, an access request including one or more access credentials and contextual information indicating one or more activities being performed by a user of the computing device; determine whether the contextual information satisfies one or more contextual conditions; whether the one or more access credentials are valid; and, responsive to determining that the one or more access credentials are valid and responsive to determining that the contextual information satisfies the one or more contextual conditions, change a state of the locking device.

In another example, various aspects of the techniques are directed to non-transitory computer-readable storage media storing instructions that,s when executed by processing circuitry, cause the processing circuitry to: receive, from a computing device, an access request including one or more access credentials and contextual information indicating one or more activities being performed by a user of the computing device; determine whether the contextual information satisfies one or more contextual conditions; whether the one or more access credentials are valid; and, responsive to determining that the one or more access credentials are valid and responsive to determining that the contextual information satisfies the one or more contextual conditions, change a state of the locking device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example environment for using context-tagged access credentials for physical access control, in accordance with one or more aspects of this disclosure.

FIG. 2 is a block diagram illustrating an example computing system, in accordance with one or more aspects of the present disclosure.

FIG. 3 is a conceptual diagram illustrating an example environment including examples of access control devices and controlled areas, in accordance with one or more aspects of the present disclosure.

FIG. 4A is a block diagram illustrating first examples of computing devices and access control systems, in accordance with one or more aspects of the present disclosure.

FIG. 4B is a block diagram illustrating second examples of computing devices and access control systems, in accordance with one or more aspects of the present disclosure.

FIG. 5 is a conceptual diagram illustrating an example process for using context-tagged access credentials for physical access control, in accordance with one or more aspects of the present disclosure.

FIG. 6 is a flowchart of a first example process for context-tagging access credentials for physical access control, in accordance with one or more aspects of the present disclosure.

FIG. 7 is a flowchart of a second example process for context-tagging access credentials for physical access control, in accordance with one or more aspects of the present disclosure.

### DETAILED DESCRIPTION

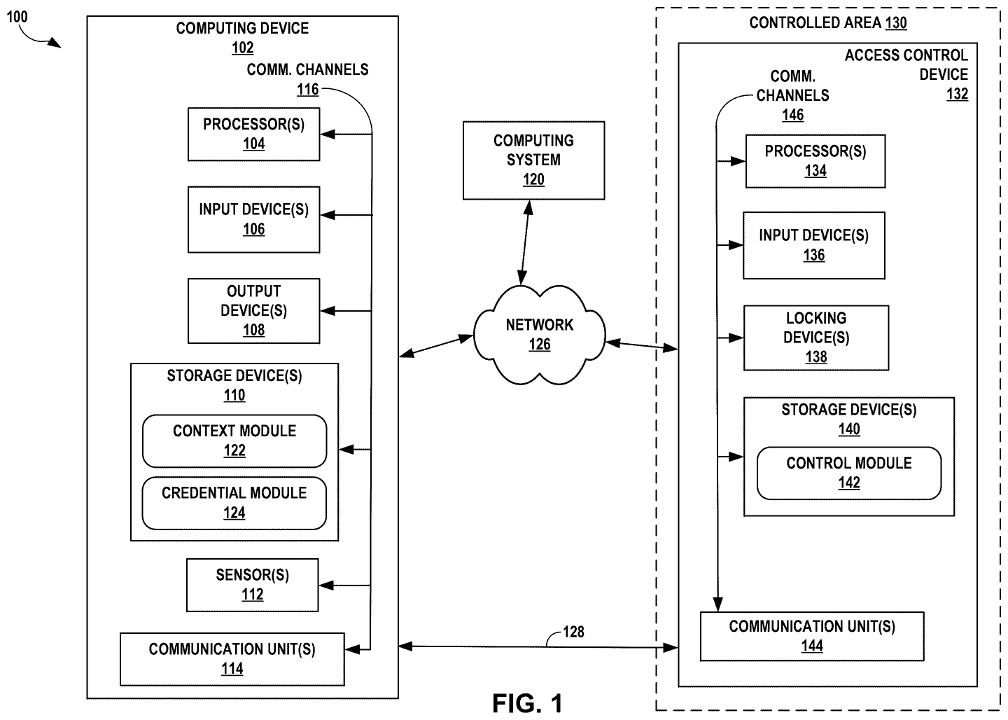

FIG. 1 is a conceptual diagram illustrating an example environment for context-tagging access credentials for physical access control, in accordance with one or more aspects of this disclosure. As can be seen, environment 100 may include one or more computing devices 102, one or more computing systems 120, and one or more access control devices 132. As described herein, computing system 120 may constitute a management system for managing access credentials (e.g., generating, distributing, invalidating access credentials) that computing devices 102 may present to access control devices 132 to access controlled areas 130 (e.g., buildings, rooms, safes, lockers, or other physical areas). Computing devices 102 may also be referred to herein as a digital key devices 102.

Computing device 102 may be, for example, a mobile phone, a tablet computer, a laptop computer, a wearable device, a gaming system, a media player, an e-book reader, or any other type of computing device that may operate as a digital key. FIG. 1 illustrates a particular example of computing device 102, and many other examples of computing device 102 may be used in other instances and may include a subset of the components included in example computing device 102 or may include additional components not shown in FIG. 1.

Computing device 102 may include or communicate with one or more processors 104, one or more input devices 106, one or more output devices 108, one or more storage devices 110, one or more sensors 112, and one or more communications units 114, or various subsets thereof. Communication channels 116 may interconnect each of the components 104, 106, 108, 110, 112, 114 for inter-component communications (physically, communicatively, and/or operatively). In some examples, communication channels 116 may include a system bus, a network connection, an inter-process communication data structure, or any other method for communicating data.

Processor 104 may implement functionality and/or execute instructions for computing device 102. Examples of processors 104 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

Processor 104 may implement functionality and/or execute instructions for computing device 102. For example, one or more processors 104 for computing device 102 may receive and execute instructions stored by one or more storage devices 110 that execute the functionality of context module 122 and credential module 124. The instructions executed by one or more processors 104 may cause computing device 102 to store information within one or more storage devices 110 during program execution. One or more processors 104 may execute instructions of context module 122 and credential module 124 to perform actions or functions. That is, context module 122 and credential module 124 may be operable by one or more processors 104 to perform various actions or functions of computing device 102.

One or more input devices 106 for computing device 102 may receive input. Examples of input are tactile, audio, and video input. Input devices 106 of computing device 102, in one example, includes a presence-sensitive display, touch-sensitive screen, mouse, keyboard, voice responsive system, video camera, microphone or any other type of device for detecting input from a human or machine.

One or more output devices 108 for computing device 102 may generate output. Examples of output are tactile, audio, and video output. Output devices 108 for computing device 102 may, for example, include a presence-sensitive display, sound card, video graphics adapter card, speaker, organic light-emitting diode (OLED), or any other type of device for generating output to a human or machine.

One or more communication units 114 for computing device 102 may communicate with external devices via one or more wired and/or wireless communication links, such as by transmitting and/or receiving wired and/or wireless signals through one or more networks or directly with the external devices. Examples of communication units 114 include a network interface card (e.g. such as an Ethernet card), an optical transceiver, a radio frequency transceiver (e.g., WI-FI® transceiver, cellular transceiver, ultra-wideband transceiver, near field NFC transceiver, BLUETOOTH® transceiver), a global navigation satellite system (GNSS) receiver, or any other type of device that can send and/or receive information. Other examples of communication units 114 may include short wave radios as well as universal serial bus (USB) controllers.

One or more storage devices 110 within computing device 102 may store information for processing during operation of computing device 102. That is, computing device 102 may store data accessed by context module 122 and/or credential module 124 during execution at computing device 102, including access credentials, contextual information, or other data. In some examples, storage device 110 may be a temporary memory, meaning that a primary purpose of storage device 110 is not long-term storage. One or more storage devices 110 on computing device 102 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 110, in some examples, also include one or more computer-readable storage media. One or more storage devices 110 may be configured to store larger amounts of information than volatile memory. One or more storage devices 110 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 110 may store program instructions and/or information (e.g., data) associated with context module 122 and credential module 124. In some examples, one or more storage devices 110 may store an operating system executed by processor 104 to provide an execution environment for context module 122, credential module 124, and/or any applications or processes installed on computing device 102.

Context module 122 and credential module 124 may execute at one or more processors 104 to perform functions related to context-tagging access credentials for physical access control. In some examples, context module 122 may generate contextual information including information corresponding to one or more activities being performed by a user of computing device 102. For instance, the user of computing device 102 may be on vehicular transport (e.g., in an automobile, on a bicycle) or on foot (e.g., walking, standing, running). It is noted that context module 122 may determine the user of computing device 102 is on foot only when the user is not in or on a vehicle. As such, context module 122 may not generate context information indicating the user is on foot when the user is standing, walking, or running in or on a vehicle. The user of computing device 102 may be inside or outside of controlled area 130 (e.g., building, room, home). The contextual information may indicate an intent in some examples. For instance, the user of computing device 102 may be arriving at controlled area 130 (e.g., building, room, home) or leaving controlled area 130.

In some examples, context module 122 may determine the user's intent based on historical information, such as historical location data (e.g., GNSS positions), historical network connection data (e.g., WI-FI or cellular connection history), historical activity data (e.g., on foot, on vehicular transport, outside controlled or other area, inside controlled or other area), assuming the user has first provided permission for use of the historical information.

Context module 122 may include one or more machine learning (ML) models to determine the user's context (e.g., the contextual information). For example, context module 122 may apply an ML model trained using a training data set including sensor or other information with corresponding activities using various types of models (e.g., K-nearest neighbor, support vector machine (SVM), random forest, decision trees, logical regression, naïve Bayes) and various training techniques (e.g., supervised, unsupervised, semi-supervised, reinforcement). In some examples, computing device 102 may train the ML model, using the training data set, and provide the trained ML model to computing device 102. Computing device 102 may validate the ML model such as by applying one or more validation data sets including examples of sensor or other information and corresponding activity indicators. Computing device 102 may determine and refine the accuracy of the ML model by comparing activity indicators generated by the ML model with the sensor or other information in the validation data set to the corresponding activity indicators provided by the validation data set. The ML model may output activity indicators identifying the user's current activity, intent, or both.

As can be seen, context module 122 may generate contextual information indicating that the user of computing device is on vehicular transport, on foot, inside controlled area 130 (or other defined area), outside controlled area 130 (or other defined area), arriving at controlled area (or other defined area), leaving controlled area 130 (or other defined area) or various subsets thereof. For privacy purposes, the contextual information may be broad or general in specificity (e.g., on foot, on vehicular transport, inside a controlled (or other) area, outside a controlled (or other) area).

Other examples of contextual information, context module 122 may generate include contextual information indicating, in addition to the above, the geographic location of computing device 102 (e.g., GNSS coordinates), the position of computing device 102 relative to another device or object (e.g., inside a vehicle, inside a room, outside a vehicle, outside a room), whether and/or at what rate and/or direction computing device 102 is traveling, rotating, tilting, or otherwise moving, or various subsets thereof. Context module 122 may include information about the user of computing device 102 in the contextual information subject to first obtaining the user's permission.

Context module 122 may generate contextual information in various ways. For example, context module 122 may generate contextual information by taking one or more readings or measurements, such as through one or more sensors 112. Sensor 112 may collect or obtain sensor information related to the circumstances of computing device 102. In some examples, sensor 112 may be a sensing or input component that obtains physical position, movement, and/or location information of computing device 102. For instance, sensors 112 may include one or more location sensors (GNSS components, WI-FI® components, cellular components, ultra-wideband components, near field communication (NFC) components), one or more temperature sensors, one or more activity or motion sensors (e.g., multi-axial accelerometers, gyros), one or more pressure sensors (e.g., barometer), one or more ambient light sensors, and one or more other sensors (e.g., microphone, camera, infrared proximity sensor, hygrometer, and the like). In some examples, one or more sensors 112 may include one or more components such as keyboards, mice, presence-sensitive housing and/or display, or other input devices.

Sensor 112 may output sensor information, including metrics, measurements, or other data, corresponding to the sensing componentry constituting sensor 112. For example, an activity sensor may output sensor information indicating an activity a user of computing device 102 is performing (e.g., walking, running, sitting, standing), a motion sensor may output sensor information indicating acceleration, speed, rotation, etc. of computing device 102, an ultra-wideband or proximity sensor may output sensor information indicating the distance or position of computing device 102 relative to another object (e.g., another computing device/system), a GNSS or other location sensor may output sensor information indicating the location (e.g., coordinates) of computing device 102, and so on.

Context module 122 may use the sensor information from sensors 112 to generate contextual information and may, in some cases, may analyze and/or combine sensor information from sensors 112 to generate the contextual information. For example, context module 122 may analyze sensor information from a motion sensor 112 to determine the user is on foot (e.g., walking, running, standing) and generate contextual information indicating the user is on foot. As another example, context module 122 may use sensor information from a proximity sensor 112 (e.g., ultra-wideband, BLUETOOTH, or NFC sensor) indicating the user is on vehicular transport to generate contextual information indicating the same. As yet another example, context module 122 may use sensor information from a location sensor 112 and/or motion sensor 112 (e.g., GNSS sensor, accelerometer) indicating the user is inside or outside controlled area 130 (or other defined area) or the user is arriving or leaving controlled area 130 (or other defined area) to generate contextual information indicating the same.

In some examples, context module 122 may receive the contextual information from a user, such as through input provided by the user. For instance, context module 122 may prompt a user for the context information and the user may respond by inputting the context information, such as by selecting or specifying an activity indicator identifying an action the user is performing). Context module 122 may determine the contextual information from user input such as one or more settings the user has selected for computing device 102. For example, an airplane mode setting for computing device 102 may constitute an activity indicator for the user being on vehicular transport.

Context module 122 may send the contextual information along with one or more access credentials to access control device 132, such as through communication unit 114. In some examples, context module 122 may send, to access control device 132, the contextual information and access credentials in the form of an access request. As will be described further below, access control device 132 may use the contextual information to determine whether to permit or deny access to controlled area 130. For example, access control device 132 may determine to deny access (e.g., lock or refrain from unlocking) to a pedestrian door of controlled area 130, even when valid access credentials are received along with the contextual information, when the contextual information indicates the user is on vehicular transport (e.g., in an automobile or on a bicycle). As another example, access control device 132 may determine to permit access (e.g., unlock) to a garage door of controlled area 130, assuming valid access credentials have been received along with the contextual information, when the contextual information indicates the user is on vehicular transport.

As can be seen, the contextual information may be advantageous relative to hands free access control, such as in the context of ultra-wideband enabled access control, where the user does not provide additional input (e.g., a user confirmation or authorization) before access control device 132 permits access at least for the reason that access control device 132 may deny access during an undesirable circumstance and thereby prevent unauthorized parties from obtaining physical access to controlled area 130. For example, access control device 132 may deny access via a pedestrian door (e.g., front door of a home) when the user is on vehicular transport as indicated by the contextual information received from computing device 102. As such, access control device 132 does not unlock the pedestrian door when the user is passing by on the vehicular transport, thereby preventing unauthorized parties from entry via the pedestrian door as the user passes by the pedestrian door on the vehicular transport.

The contextual information may be used by access control device 132, computing device 102, or both. For example, in a non-hands free case (e.g., BLUETOOTH enabled access control), computing device 102 may utilize the contextual information to determine whether to notify or prompt the user for input (e.g., authorization or confirmation) before sending an access request to access control device 132. For instance, computing device 102 may not prompt a user for confirmation to unlock a pedestrian door when the contextual information indicates the user is on vehicular transport. As another example of a non-hands free case, computing device 102 may utilize the contextual information to determine which access credential of a plurality of access credentials to present to access control device 132. For instance, computing device 102 may be in sufficient proximity to multiple access control devices 132 for various doors or other openings and may retrieve and present different access credentials based on the contextual information. To illustrate, computing device 102 may present the access credential for a first access control device 132 (e.g., garage door opener) when the contextual information indicates the user is on vehicular transport and present the access credential for a second access control device 132 (e.g., pedestrian door access control reader) when the contextual information indicates the user is on foot (e.g., walking). In this example, the first and second access control devices 132 may be within sufficient proximity of one another to cause at least some ambiguity as to which access control device 132 the user intends to use.

Credential module 124 may store access credentials, such as in a database or other structured data format, to storage device 110. Some examples of access credentials include digital tokens, keys, usernames, passwords, or other authentication information. In some examples, access credentials may comprise cryptographic tokens or keys or may be other encrypted authentication information, including tokens, passcodes, usernames, and passwords. In operation, context module 122 may present (e.g., send) the contextual information along with one or more access credentials to access control device 132, such as in the form of an access request, to request physical access to controlled area 130.

Context module 122 may manage (e.g., store, update, delete, retrieve) access credentials in credential module 124. For example, context module 122 may store access credentials to credential module 124 and may update and delete access credentials in credential module 124, such as when the access credentials are renewed or invalidated (e.g., revoked, removed, expired). In some examples, context module 122 may receive management instructions from computing system 120 and may perform particular management functions (e.g., storing, updating, deleting access credentials) with respect to locally disposed access credentials (e.g., access credentials stored by storage device 110) in response to the management instructions.

Computing system 120 may constitute a management system for one or more access control devices 132 at one or more controlled areas 130 and one or more computing devices 102. For example, computing system 120 may register one or more computing devices 102, one or more access control devices 132, and one or more controlled areas 130, such as part of a provisioning process. Each controlled device 132 may be provisioned at computing system 120 using an administrator device. The administrator device may be any computing device, including computing device 102, that is configured to provision one or more controlled devices 132. During the provisioning process, the administrator device may provide contextual information about the one or more controlled devices 132 to computing system 120. Such contextual information may include a type of the controlled device 132 (e.g., a type of the door, which may be represented by a variable “Door_Type”). The door types may include, as non-limiting examples, a pedestrian door, a garage door, a security door, a vault door, a turnstile, an automatic door, a revolving door, a sliding door, a gate, a roll-up door, etc. The contextual information may also include a list of types of user interactions that are likely and/or unlikely to occur when a user is attempting to unlock or otherwise enable the user to access a controlled area managed by the particular access control device 132. In some examples, the list of the types of user interactions may be provided using a variable named “User_Activity.” The types of user interactions may include types of user activity, such as walking, running, cycling, driving, skating (e.g., on roller blades, ice skates, etc.), dancing, jumping, etc. The contextual information may also include a side of access control device 132 from which the user needs to be approaching from in order to provide access to controlled area 130. For example, the contextual information may specify that access control device 132 may provide access when the user approaches from either side of access control device 132 (e.g., from within controlled area 130 or from outside of controlled area 130). As another example, the contextual information may specify that access control device 132 may provide access only when the user approaches access control device 132 from outside of controlled area 130. Similarly, the contextual information may specify that access control device 132 may provide access only when the user approaches access control device 132 from inside of controlled area 130.

Each access control device 132 may be provisioned with multiple and/or secondary tags. For example, garage door may be tagged with Door_Type=roll-up garage door. The garage door may be tagged with User_Activity=driving and User_Activity=walking. In some examples, the garage door may be further tagged with enabling access when the user is approaching access control device 132 from either side while driving but only from the inside while walking.

Computing system 120 may register such contextual information by storing, such as in a storage device of computing system 120, management information including an indication of one or more computing devices 102, one or more access control devices 132 (including a type of access control device 132), one or more controlled areas 130 computing system 120 is responsible for managing, and one or more types of user interactions that a user is likely and/or unlikely to be engaged in when attempting to one or more access controlled areas 130. Computing system 120 may store the management information in a database or other structured data format on the storage device.

In some examples, rather than providing the contextual information to computing system 120 during provisioning, access control device 132 may provide the contextual information to computing system 120 during an authentication transaction. That is, computing system 120 may authenticate a user based on the information provided by computing device 102 as well as the contextual information provided by access control device 132. For example, computing device 102 may provide an indication of a user activity and authentication credentials to computing system 120 while access control device 132 may provide an indication of a door type and one or more user interaction types associated with access control device 132. In some instances, rather than providing the indication of the user activity and authentication credentials directly to computing system 120, computing device 102 may provide the indication of the user activity and the authentication credentials to access control device 132 and access control device 132 (e.g., by including the information in extended BLUETOOTH Low Energy advertisements output by computing device 102) may provide the indication of the user activity and the authentication credentials in addition to the door type and the one or more user interaction types to computing system 120. Using the indication of the user activity and the authentication credentials received from computing device 102 and the door type and the one or more user interaction types received from access control device 132, computing system 120 may determine whether the access credentials are valid and may determine whether the contextual information (e.g., the user activity from computing device 102) satisfies the one or more contextual conditions (e.g., the one or more user interaction types from access control device 132).

The management information may indicate which access control devices 132 correspond to which controlled areas 130. For example, computing system 120 may store an indication of the respective controlled area 130 where each access control device 132 is located or installed in the management information. Computing system 120 may store an indication of the respective computing devices 102 that are assigned to (e.g., paired to) each access control device 132 in the management information. Computing system 120 may send to computing devices 102 an indication of access control devices 132 to which computing devices 102 are assigned, send to access control devices 132 an indication of computing devices 102 to which access control devices 132 are assigned, or both. In this manner, computing devices 102 and/or access control devices 132 may refrain from communicating (e.g., refrain from communicating access requests) with unknown (e.g., unregistered, unpaired) devices.

In some examples, computing system 120 may group access control devices 132 into one or more groups such as by assigning access control devices 132 to one or more groups (e.g., group 1, group 2, . . . group n). Computing system 120 may assign access control devices 132 within a group to one or more subgroups (e.g., subgroup 1, subgroup 2, . . . subgroup n). Computing system 120 may store an indication of the group and/or subgroup to which each access control device 132 is assigned in the management information.

Computing system 120 may utilize such groupings and/or subgroupings to apply configuration settings across a number of access control devices 132. For example, computing system 120 may apply the same configuration settings to each access control device 132 of a group (e.g., group 1). For instance, computing system 120 may specify contextual conditions (e.g., criteria) contextual information must satisfy for each access control device 132 within a group or subgroup. Computing system 120 may store, such as in the management information, an indication of the contextual information assigned to a group or subgroup. Computing system 120 may send various sets of contextual conditions to groups and/or subgroups of access control devices 132. Access control devices 132 may receive respective contextual conditions and store the contextual conditions, such as at storage device 140. Access control device 132 may permit or deny access to controlled area 130 based on the contextual conditions, as will be described further below.

In some examples, computing system 120 may specify the contextual conditions for access control devices 132 during provisioning or registration of access control devices 132. Computing system 120 may assign contextual conditions to respective access control devices 132 in the management information, such as by storing the contextual conditions for each access control device 132 in a “CONTEXT” field within the management information for each access control device. In some examples, such “CONTEXT” field may be a column of a database or other field in a database or other structured data format.

In some examples, computing system 120 may send a first set of contextual conditions to a group of access control devices 132 including each access control device 132 at the exterior perimeter of controlled area 130 (e.g., exterior doors of a building). Continuing this example, computing system 120 may send a second set of contextual conditions to a subgroup of the group of access control devices 132 (e.g., garage doors of controlled area 130). As such, the first set of contextual conditions may, for example, require the user to be outside and the second set of contextual conditions may, for example, require the user to be on vehicular transport.

Computing device 102 may function according to the contextual conditions in some examples. As described above, during non-hands free operation, computing device 102 may prompt a user for additional input (e.g., authorization or confirmation) prior to requesting physical access from access control device 132. In such a case, computing device 102 may determine whether to prompt a user for the additional input based on the contextual conditions of access control device 132. Continuing the above example for instance, computing device 102 may require the user to be outside before prompting the user for additional input when computing device 102 is used with access control device 132 with the first set of contextual conditions and may require the user to be on vehicular transport when computing device 102 is used with access control device 132 with the second set of contextual conditions.

In some examples, computing system 120 may generate and distribute (e.g., send) access credentials to computing devices 120 and validation information for validating access credentials to access control devices 132. For example, computing system 120 may generate an access credential, such as cryptographic key or token, for computing device 102 assigned to access control device 132 and transmit the access credential to computing device 102. Computing system 120 may reference the management information to identify computing device 102 and access control device 132. Credential module 124 of computing device 102 may receive the access credential and store the access credential, such as to storage device 110. Context module 122 may subsequently present (e.g., send) the access credential to access control device 132 assigned to controlled area 130 to allow the user to obtain access to controlled area 130. Access control device 132 may store the validation information and utilize the validation information to validate the presented access credential. Computing system 120 may, in some examples, utilize a public key infrastructure (PKI) to generate cryptographic keys or tokens that constitute access credentials and validation information. In such examples, computing devices 102 and access control devices 132 may utilize corresponding public and private keys to encrypt, decrypt, sign, and/or validate access credentials.

In some examples, computing system 120 may invalidate (e.g., revoke, delete) access credentials. For example, computing system 120 may transmit one or more management instructions to access control device 132 and/or computing device 102 that causes access control device 132 and/or computing device 102 to invalidate one or more access credentials identified in the management instructions. When presented with an invalid access credential, access control device 132 may deny access to controlled area 130.

Computing system 120 may communicate with one or more computing devices 102 and one or more access control devices 132, such as through network 126. Network 126 may represent any public or private communications network, for instance, cellular, WI-FI, and/or other types of networks, for transmitting data between computing systems, servers, and computing devices. Network 126 may include one or more network hubs, network switches, network routers, or any other network equipment, that are operatively inter-coupled thereby providing for the exchange of information between computing system 120, computing device 102, access control device 132, or various subsets thereof. Computing device 102, access control device 132, and computing system 120 may transmit and receive data across network 126 using any suitable communication techniques. For example, access credentials and other data may be transmitted and received between computing system 120, computing device 102, and access control device 132, or various subsets thereof via network 126. Each of computing device 102, access control device 132, and computing system 120 may be operatively coupled to network 126 using respective network links, such as Ethernet, Wi-Fi, or any other types of wired and/or wireless network connections. Wired and/or wireless connections between devices/systems may be made through respective communication units (e.g., communication unit 114 of computing device 102 and communication unit 144 of access control device 132).

Access control device 132 may control access to a controlled area 130, such as a building, room, safe, locker, or other physical area. Access control device 132 may permit or deny access to controlled area 130 by controlling operation of one or more locking devices 138 (e.g., locks), such as of a doorway or other opening of controlled area 130. Examples of access control devices 132 include access control readers (e.g., badge readers, card readers), smart locks, digital locks, biometric locks, and the like. As can be seen from the example of FIG. 1, access control device 132 may comprise one or more processor 134, one or more communication units 144, and one or more locking devices 138. In some examples, access control device 132 may include one or more input devices 136 and one or more storage devices 140. Communication channels 146 may interconnect each of the components 134, 136, 138, 140, 144 for inter-component communications (physically, communicatively, and/or operatively). In some examples, communication channels 146 may include a system bus, a network connection, an inter-process communication data structure, or any other method for communicating data

Processors 134, input devices 136, storage devices 140, and communication units 144 of access control device 132 may be similarly composed as processors 104, input devices 136, storage devices 110, and communication units 114, respectively, as described above in connection with computing device 102. For example, processor 134 may implement functionality and/or execute instructions within access control device 132 to implement the functionality of access control device 132 and may include integrated or discrete logic circuitry (e.g., DSPs, ASICs, CPUs, FPGAs) or any other hardware configured to function as a processing unit. Processor 134 of access control device 132 may receive and execute instructions stored by one or more storage devices 140 that execute the functionality of control module 142. The instructions executed by one or more processors 134 may cause access control device 132 to store information within one or more storage devices 140 during program execution. One or more processors 134 may execute instructions of control module 142 to perform actions or functions. That is, control module 142 may be operable by one or more processors 134 to perform various actions or functions of access control device 132.

One or more input devices 136 of access control device 132 may receive input, such as tactile, audio, and video input. Input devices 136 of access control device 132, in one example, includes a presence-sensitive display, touch-sensitive screen, mouse, keyboard, voice responsive system, video camera, microphone or any other type of device for detecting input from a human or machine. Such input may be a code (e.g., personal identification number (PIN)), biometric information, or the like that access control device 132 may validate to permit access.

One or more storage devices 140 for access control device 132 may store information for processing during operation of access control device 132. That is, storage device 140 may store data accessed by control module 142, including validation information for validating access credentials (e.g., PKI public/private keys), access credentials, contextual information, or other data. In some examples, one or more storage devices 140 may store an operating system executed by processor 134 to provide an execution environment for control module 142, and/or any applications or processes installed on access control device 132.

One or more locking devices 138 of access control device 132 may unlock to permit access to controlled area 130 and lock or remain locked (e.g., refrain from unlocking) to deny access to controlled area 130. Locking devices 138 may comprise one or more actuators, motors, servos, electromagnets, magnets, or the like to lock and unlock a bolt or latching mechanism of locking device 138. Examples of locking devices 138 include electronic locks such as electric strike locks, electronic deadbolt locks, magnetic or electromagnetic locks, electronic lever locks, or the like.

One or more communication units 144 of access control device 132 may communicate with external devices via one or more wired and/or wireless communication links, such as by transmitting and/or receiving wired and/or wireless signals through one or more networks 126 or directly with the external devices. As shown in the example of FIG. 1 for instance, access control device 132 may communicate with computing system 120 through communication unit 144 and network 126. Computing device 102 and access control device 132 may communicate directly via respective communication units (e.g., communication unit 114 and communication unit 144), such as shown by direct communication link 128 between computing device 102 and access control device 132 in the example of FIG. 1. In some examples, direct communication link 128 may be a wireless communication link, such as a BLUETOOTH, WI-FI, NFC, ultra-wideband, or other wireless communication link. Computing device 102 may use direct communication link 128, network 126, or both to send contextual information and access credentials, such as in one or more access requests, to access control device 132.

Control module 142 may execute at one or more processors 134, to permit or deny access to controlled area 130 by changing a state of one or more locking devices 138 (e.g., locks), such as of a doorway or other opening of controlled area 130. For example, to permit access, control module 142 may change the state of locking device 138 to an unlocked state and, to deny access, control module 142 may refrain from changing the state of locking device 138 to the unlocked state or may change the state of locking device 138 to a locked state. In some examples, control module 142 may operate a mechanical, electrical, magnetic or other mechanism of locking device 138 to change the state of locking device 138. For instance, to change the state of locking device 138 to an unlocked state, control module 142 may release an electric strike, retract a deadbolt, release a magnetic or other latch, or the like. To change the state of locking device 138 to a locked state, control module 142 may, for example, lock an electric strike, extend a deadbolt, activate/engage a magnetic or other latch, or the like.

Control module 142 may receive one or more contextual conditions for access control device 132 from computing system 120, such as through network 126 and communication units 144. Similarly, control module 142 may receive the validation information from computing system 120. Storage devices 140 may store the contextual conditions, the validation information, or both. In operation, control module 142 may receive an access request from computing device 102. The access request may include the contextual information and one or more access credentials of computing device 102. Control module 142 may compare the contextual information to one or more contextual conditions and validate the access credentials with the validation information. Assuming control module validates the access credentials, control module 142 may permit access (e.g., unlock locking device 138) to controlled area 130 when the contextual information satisfies the contextual conditions and deny access (e.g., refrain from unlocking locking device 138 or lock locking device 138) to controlled area 130 when the contextual information does not satisfy the contextual conditions. Control module 142 may deny access to controlled area 130 when control module 142 is unable to validate the access credentials. Control module 142 may validate the access credentials by matching the access credentials to the validation information, through PKI encryption, such as by using one or more public/private keys in the validation information to validate the access credentials, or the like.

Examples of the operation of control module 142 with respect to some examples of current context of the user and contextual conditions are provided in the following Table 1. In the example of Table 1, it is assumed that the access credentials are valid. Control module 142 may deny access when the access credentials are invalid regardless of the contents of the contextual information. Contextual Conditions of table 1 may represent the User_Activity contextual information provided during a provisioning process. Current Context may represent a currently determined user interaction, such as walking, driving, on foot, on vehicular transport, etc. In various instances, the list of potential user interactions is the same as the list of potential user activities.

TABLE 1

| Contextual Condition(s) | Current Context | Permit or Deny Access? |
|---|---|---|
| On a vehicular transport | On foot | Deny |
| On a vehicular transport | On vehicular transport | Permit |
| On vehicular transport and | On vehicular transport | Deny |
| outside controlled area | | |
| On vehicular transport or | On vehicular transport | Permit |
| outside controlled area | | |
| On foot | On foot | Permit |
| On foot and outside | On foot | Deny |
| controlled area | | |
| On foot and outside | On foot and outside | Permit |
| controlled area | controlled area | |
| Arriving at controlled area | Inside controlled area | Deny |
| Arriving at controlled area | Arriving at controlled area | Permit |

As can be seen, the contextual conditions and contextual information may each include one or more activity indicators (e.g., on foot, on vehicular transport, inside controlled area, outside controlled area). Control module 142 may permit access when at least one of the activity indicator(s) of the contextual information corresponds to (e.g., match) each of the activity indicator(s) of the contextual conditions. In some cases, control module 142 may treat some activity indicators as optional (e.g., on vehicular transport “or” outside controlled area) using a logical “or” operator. As such, control module 142 may not require a corresponding activity indicator in the contextual information for optional contextual condition activity indicators. As such, by receiving an access request that includes both access credentials and contextual information, the access control device can make more informed decisions about whether to permit or deny access. This dual-check mechanism enhances security by ensuring that access is granted not only based on valid access credentials but also on the context in which the request is made, such as the user's current activity.

Access control device 132 may accordingly determine whether to permit or deny physical access based on the contextual information. In this manner, access control device 132 may, for example, refrain from permitting access when the contextual information indicates access should not be permitted even when the access credentials are valid. For example, access control device 132 for controlled area 130 comprising an automobile or bicycle garage may refrain from permitting access when the contextual information indicates the user of computing device 102 is not on vehicular transport. That is, if the Door_Type is provisioned as garage door and the User_Activity is provisioned as driving, if computing device 102 determines that the user is on vehicular transport (e.g., determines that the user is driving or riding in a vehicle) and receives valid credentials from computing device 102, access control device 132 may determine that the determined User_Activity matches the provisioned User_Activity and may provide access to controlled area 130. However, if the determined User_Activity is walking, access control device 132 may determine that the determined User_Activity does not match the provisioned User_Activity and may deny access to controlled area 130.

As another example, access control device 132 for controlled area 130 comprising a pedestrian door may not permit access when the contextual information indicates the user is passing by on vehicular transport, or access control device 132 for an exterior door (e.g., front door) of a controlled area 130 comprising a home may only permit access when the contextual information indicates the user is outside as opposed to inside the home.

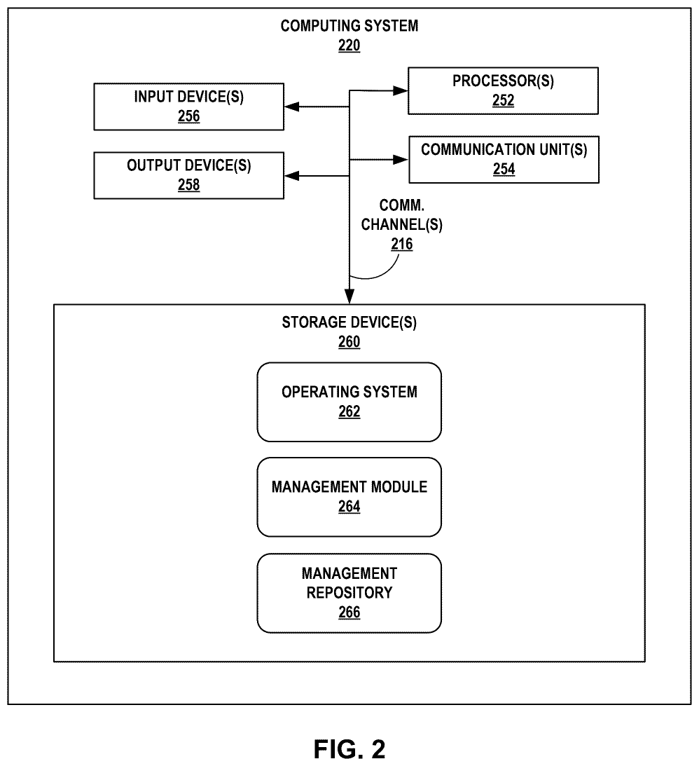

FIG. 2 is a block diagram illustrating an example computing system, in accordance with one or more aspects of the present disclosure. Computing system 220 may be an example of one or more computing devices such as servers, desktop computing devices, computing devices integrated into devices providing a service (e.g., server appliances), among other types of computing devices. As can be seen from the example of FIG. 2, computing system 220 may include one or more processors 252, one or more communication units 254, one or more storage devices 260. In some examples, computing system 220 may include one or more input devices 256 and one or more output devices 258. Computing system 220 may include communication channels 216. Communication channels 216 may interconnect each of the components 252, 254, 256, 258, 260 for inter-component communications (physically, communicatively, and/or operatively). In some examples, communication channels 216 may include a system bus, a network connection, an inter-process communication data structure, or any other method for communicating data. Computing system 220 of FIG. 2 may be an example of computing system 120 of FIG. 1.

One or more communication units 254 of computing system 220 may communicate with external devices via one or more wired and/or wireless networks by transmitting and/or receiving network signals on the one or more networks. Examples of communication units 254 include a network interface card (e.g. such as an Ethernet card), an optical transceiver, a radio frequency transceiver, a GNSS receiver, or any other type of device that can send and/or receive information. Other examples of communication units 254 may include short wave radios, cellular data radios, wireless network radios, as well as universal serial bus (USB) controllers.

One or more input devices 256 may include one or more components such as keyboards, mice, presence-sensitive housing and/or display, or other input components. One or more output devices 258 may generate output. Examples of output are tactile, audio, and video output. Output devices 258 of computing system 220, in one example, includes a presence-sensitive display, sound card, video graphics adapter card, speaker, OLED, or any other type of device for generating output to a human or machine.

Computing system 220 may provide a user interface to allow a user (e.g., an administrator) to configure and operate computing system 220. For example, computing system 220 may provide a local graphical user interface (GUI) through one or more input devices 256 and/or one or more output devices 258. Computing system 220 may provide a remote user interface, such as a dashboard or other Web user interface (Web UI) through one or more communication units 254. Computing system 220 may receive, such as through the user interface and via input device 256 and/or communication unit 254, user input to register, setup, assign, and/or manage computing devices, access control devices, and controlled areas, as well as to receive configuration settings, such as contextual conditions for one or more of computing devices and/or access control devices, and pair computing devices and access control devices.

One or more processors 252 may implement functionality and/or execute instructions within computing system 220. Examples of processors 252 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. Management module 264 and management repository 266 may execute at one or more processors 252 to manage computing devices 102, access control devices 132, access credentials, and contextual conditions, such as described above with respect to FIG. 1.

One or more storage devices 260 within computing system 220 may store information for processing during operation of computing system 220. In some examples, storage devices 260 are temporary memory, meaning that a primary purpose of storage device 260 is not long-term storage. Storage devices 260 on computing system 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 260, in some examples, also include one or more computer-readable storage media. Storage devices 260 may be configured to store larger amounts of information than volatile memory. Storage devices 260 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage devices 260 may include operating system 262, management module 264, and management repository 266. As shown in FIG. 2, storage device 260 may include operating system 262 that provides an execution environment for one or more applications, such as management module 264 and management repository 266.

Management repository 266 may store management information, contextual conditions, and other data used to provide context-tagged access credentials for physical access control. Management repository 266 may store the management information and other data in a database or other structured data format. Management module 264 may manage (e.g., store, update, delete) the management information in management repository 266. Management module 264 may provide the management functionality described above with respect to computing system 120 of FIG. 1. For example, management module 264 may register devices/entities (e.g., computing devices 102, access control devices 132, controlled areas 130), assign access control devices 132 to one or more groups and/or subgroups, assign (e.g., pair) computing devices 102 to access control devices 132, and store contextual conditions for access control devices 132. Management module 264 may provision (e.g., send) and invalidate access credentials at computing devices 102 and provision and invalidate validation information at access control devices 132.

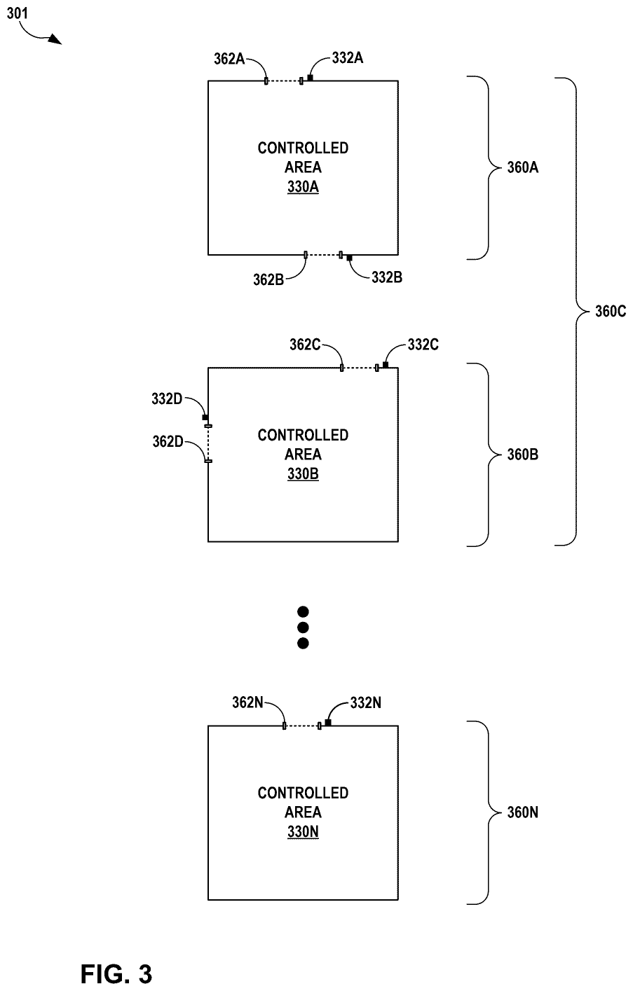

FIG. 3 is a conceptual diagram illustrating an example environment including examples of access control devices and controlled areas, in accordance with one or more aspects of the present disclosure. As can be seen, environment 301 may include one or more controlled areas 330A-330N (collectively, “controlled areas 330”) and one or more access control devices 332A-332N (collectively, “access control devices 332”) installed at one or more access points 362A-362N (collectively, “access points 362”). In some examples, access points 362 may be openings, such as doorways, that allow physical access to controlled areas 330. As shown, controlled areas 330 may be defined areas such as physical areas delineated by walls, fencing, railing, or other barriers. FIG. 3 is described below in the context of FIG. 1. For example, controlled areas 330 and access control devices 332 of FIG. 3 may respectively be examples of controlled areas 130 and access control devices 132 of FIG. 1.

As described above, computing system 120 may assign, based on user input, access control devices 332 to one or more groups 360A-360N (collectively, “groups 360”) which, when at least partially nested within an encompassing group may be referred to a subgroups 360A-360N (collectively, “subgroups 360). As shown in FIG. 3 for example, subgroups 360A, 360B may be within group 360C and group 360N may be an independent group of access control devices 332. Computing system 120 may assign a group identifier (group ID) (e.g., group 1, group 2, . . . group n) to each group (e.g., group 360C, 360N) and a subgroup identifier (subgroup ID) (e.g., subgroup 1, subgroup 2, . . . subgroup n) to each subgroup (e.g., 360A, 360B). In the example of FIG. 3, access control devices 332A, 332B are assigned to subgroup 360A, access control devices 332C, 332D are assigned to subgroup 360B, and access control devices 332A-332D are assigned to group 360C.

Computing system 120 may use groups and subgroups to organize access control devices 332. For example, computing system 120 may assign access control devices 332 to group 360C representing a first campus and assign control device 332 to subgroups 360A, 360B representing controlled areas 330A, 330B (e.g., buildings) within the first campus. In this example, computing device 102 may assign access control device 332N to group 360N, representing a separate controlled area 330N or second campus. In this manner, computing system 120 may uniformly apply configuration settings (e.g., contextual conditions and/or validation information) to multiple access control devices 332 by applying the configuration settings to a group (e.g., group 360C, 360N) or subgroup (e.g., subgroup 360A, 360B).

For example, controlled area 330A may be an office and controlled area 330B may be a garage. In this example, computing system 120 may send first contextual conditions requiring a user to be on foot to access control devices 332A, 332B within subgroup 360A and send second configuration settings including contextual conditions requiring the user to be on vehicular transport to access control devices 332C, 332D within subgroup 360B. Computing system 120 may send validation information to the entire group of access control devices by sending the validation information to access control devices 332A-332D within group 360C. As such, the validation information applies to access control devices within group 360C, the first contextual conditions apply to access control devices within subgroup 360A, and the second contextual conditions apply to access control devices within subgroup 360B. Continuing this example, controlled area 360C (e.g., a warehouse) may be restricted to different users. As such, computing system 120 may send different validation information to access control device 332N of group 360N as compared to that of group 360C.

Access control devices 332 may store and reference the configuration settings (e.g., contextual conditions and validation information) from computing system 120 and operate according to such configuration settings. Continuing the above example for instance, access control devices 332A, 332B within subgroup 360A may require contextual information indicating the user is on foot before permitting access to controlled area 330A, and access control devices 332C, 332D within subgroup 360B may require receipt of contextual information indicating the user is on vehicular transport before permitting access to controlled area 330B.

Access control devices 332 may receive, from computing system 120, a group ID and/or subgroup ID for each group and/or subgroup access control devices 332 are within. Access control devices 332 may advertise (e.g., transmit) their respective group IDs and/or subgroup IDs in some examples, such as to allow computing devices 102 to identify the access credential for each respective access control device 332. For example, subgroup 360A and subgroup 360B may respectively be accessible to different sets of users. As such, computing device 102 may present different access credentials at access control devices 332A, 332B as compared to access control devices 332C, 332D based on the subgroup ID advertised by the access control devices (e.g., subgroup ID 1 for access control devices 332A, 332B and subgroup ID 2 for access control devices 332C, 332D). Since access control devices 332A-332D are within group 360C, each of access control devices 332A-332D may have the same group ID (e.g., group ID 1).

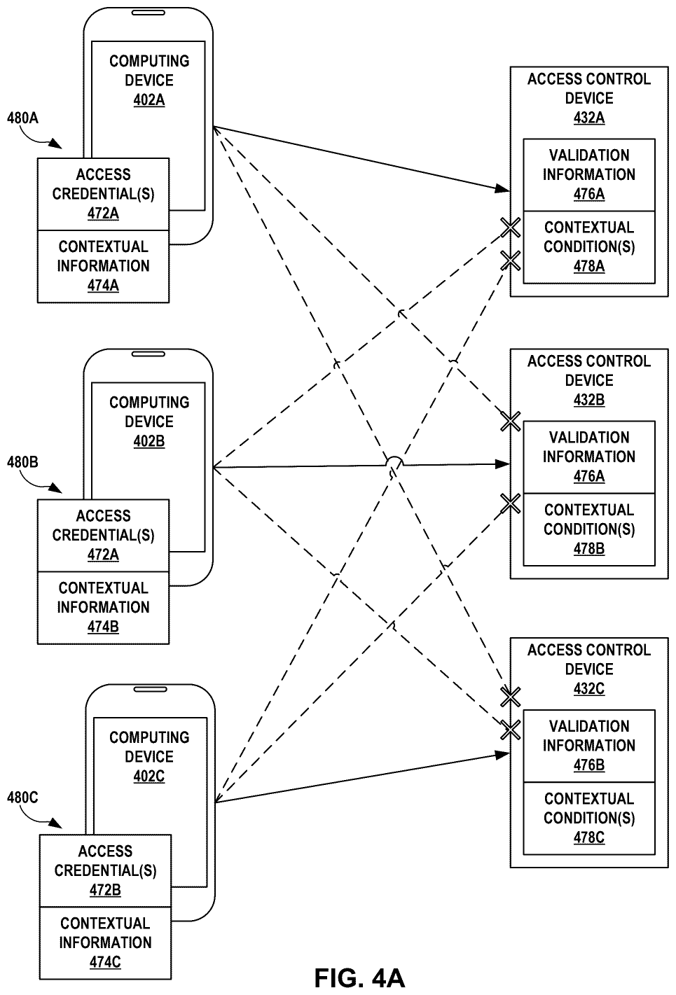

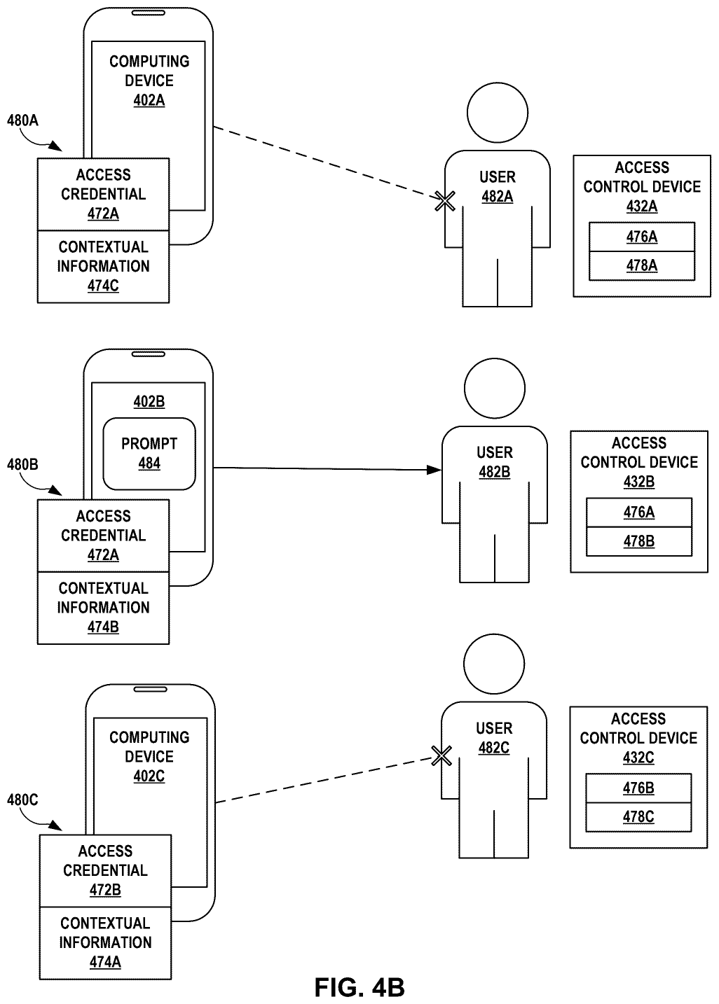

FIG. 4A is a block diagram illustrating first examples of computing devices and access control systems, in accordance with one or more aspects of the present disclosure. FIG. 4A illustrates examples of access requests 480A-480C (collectively, “access requests 480”) sent by computing devices 402A-402C (collectively, “computing devices 402”) to respective access control devices 432A-432C (collectively, “access control devices 432”). FIG. 4A is described below in the context of FIG. 1. For example, computing devices 402 and access control devices 432 of FIG. 4 may respectively be examples of computing devices 102 and access control devices 132 of FIG. 1. In the example of FIG. 4A, the solid lines between computing devices 402 and access control devices 432 represent successful access requests 480 and the broken lines between computing devices 402 and access control device 432 represent invalid access requests 480. Access control device 432 may respond to successful access requests 480 by permitting access to controlled area 130 and respond to invalid access requests 480 by denying access to controlled area 130.

As can be seen, access requests 480 may each include one or more access credentials 472A-472B (collectively, “access credentials 472”) and contextual information 474A-474C (collectively, “contextual information 474”). Access credentials 472 and contextual information 474 may respectively be examples of the access credentials and contextual information described in connection with FIG. 1. Access requests 480 may, in some examples, conform to a request structure. For example, access request 480 may include various fields where data for access request 480 may be stored. For instance, access request 480 may include a “CONTEXT” field storing context information 474, a “ACCESS CREDENTIALS” field storing access credentials 472, a “GROUP ID” field including a group ID for access control device 432, a “SUBGROUP ID” field including a subgroup ID for access control device 432, or various subsets thereof. An example of such access request 480 is shown below in Table 2. In some examples, the group ID and/or subgroup ID may be included in access request 480, such as to allow access control device 432 to confirm that access request 480 is intended for access control device 432 as opposed to another access control device 432 with a different group ID and/or subgroup ID. The “CONTEXT” field may be added to standards-based protocols, including open access standards such as Aliro (https://csa-iot.org/all-solutions/aliro/).

TABLE 2

| Field | Data |
|---|---|
| GROUP ID | 1 |
| SUBGROUP ID | 2 |
| ACCESS CREDENTIALS | a7816bf8f01cfea414140de5dae2223b0036 |
| CONTEXT | On foot |

Access control devices 432 may respectively include validation information 476A-476B (collectively, “validation information 476”), contextual conditions 478A-478C (collectively, “contextual conditions 478”), or both. Validation information 476 and contextual conditions 478 may respectively be examples of validation information and contextual conditions 478 described in connection with FIG. 1.

As described above, access control device 432 may not permit access to controlled area 130 unless access credentials 472 are valid, such as with respect to corresponding validation information 476. For instance, in the example of FIG. 4A, access credential 472A may only be valid when validated, by access control device 432, using validation information 476A and access credential 472B may only be valid when validated, by access control device 432, using validation information 476B. Relative to contextual information 474, access control device 432 may not permit access to controlled area 130 unless contextual information 474 satisfies one or more contextual conditions 478. In the example of FIG. 4A for instance, contextual information 474A may satisfy contextual conditions 478A, contextual information 474B may satisfy contextual conditions 478B, and contextual information 474C may satisfy contextual conditions 478C.

Accordingly, when computing device 402A sends access request 480A to access control device 432A, the access request 480A is successful and when computing device 402A sends access request 480A to access control devices 432B, 432C, access request 480A is invalid. When computing device 402B sends access request 480B to access control device 432B, the access request 480B is successful and when computing device 402B sends access request 480B to access control devices 432A, 432C, access request 480B is invalid. Likewise, when computing device 402C sends access request 480C to access control device 432C, the access request 480C is successful and when computing device 402C sends access request 480C to access control devices 432A, 432B, access request 480C is invalid.

Computing device 402 may refrain from sending access request 480 based on the contextual conditions 478 associated with access control devices 432. For example, contextual conditions 478A may require the user to be on foot while contextual conditions 478B may require the user to be on vehicular transport. As such, assuming computing device 402A determines the user is on foot, computing device 402 may send access request 480A to access control device 432A and refrain from sending any access request 480 to access control devices 432B, 432C even though computing device 402 may be in sufficient proximity to communicate with access control device 432A and one or more of access control devices 432B, 432C.

In some examples, computing device 402 may determine whether contextual information 474 satisfies conditional conditions 478 and send only access credentials 472 (e.g., access request 480 without contextual conditions 478) to access control device 432. For instance, contextual conditions 478A may require the user to be on foot and computing device 402A may locally determine whether contextual information 474A satisfies contextual conditions 478A. If contextual information 474A satisfies contextual conditions 478A, computing device 402A may send only access credentials 472 (e.g., access request 480 without contextual conditions 478) to access control device 432A. In this manner, contextual information 474 may be retained by computing devices 402 and not shared with access control devices 432.

FIG. 4A may be considered as an example of hands free operation in that computing devices 402 may send access request 480 to access control device 432 automatically and without additional input from the user (e.g., without requiring user confirmation or authorization). For example, computing device 402 may automatically send access request 480 when computing device 402 moves within a threshold distance of access control device 432, as may be determined by ultra-wideband or other proximity detection technologies. Accordingly, when access request 480 is successful, access control device 432 may permit access without any additional input from the user.

FIG. 4B is a block diagram illustrating second examples of computing devices and access control systems, in accordance with one or more aspects of the present disclosure. FIG. 4B may be considered as an example of non-hands free operation in that additional input (e.g., user confirmation or authorization) may be required before computing device 402 sends access request 480. As compared to FIG. 4A, FIG. 4B includes users 482A-482C (collectively, “users 482”) at respective access control devices 432A-432C that must provide the additional input before computing devices 402 may send access requests 480. FIG. 4B is described below in the context of FIG. 1. As can be seen, computing devices 402 may obtain the additional input through a prompt 484 (e.g., a notification or message) presented to the user, such as through an output device 108. Computing device 402 may receive the additional input from user 482 through an input device 106.

Computing device 402 may determine whether to present prompt 484 and receive the additional input based on contextual information 474 relative to contextual conditions 478. For example, computing device 402 may present prompt 484 when contextual information 474 satisfies contextual conditions 478 and refrain from presenting prompt 484 when contextual information 474 does not satisfy contextual conditions 478.

In the example of FIG. 4B, contextual information 474A may satisfy contextual conditions 478A, contextual information 474B may satisfy contextual conditions 478B, and contextual information 474C may satisfy contextual conditions 478C. As such, the solid line between computing device 402B and user 482B represents presentation of prompt 484 to user 482A whereas the broken lines between computing devices 402 and access control devices 432 represent cases where no prompt is presented because respective contextual conditions 478 are not satisfied. For example, computing device 402A may not present prompt 484 to user 482A because contextual information 474A of computing device 402A does not satisfy contextual conditions 478A corresponding to access control device 432A. Similarly, computing device 402C does not present prompt 484 to user 482C because contextual information 474C of computing device 402C does not satisfy contextual conditions 478C corresponding to access control device 432C.

As described in connection with the example of FIG. 4A, access credential 472B may only be valid when validated, by access control device 432, using validation information 476B. Accordingly, when user 482B provides confirmatory additional input (e.g., confirmation or authorization) to computing device 402B, computing device 402B may send access request 480B to access control device 432B. Access control device 432B may permit access to controlled area 130 since, in this example, access credential 472A is valid relative to validation information 476A and contextual information 474B satisfies contextual conditions 478B.

In some examples, computing device 402 may validate the authentication information that the user provides as additional input. For example, computing device 402 may receive a passcode, password, biometric information (e.g., fingerprint), or the like as the additional input and validate the same. Computing device 402 may refrain from ending access request 480 when the authentication information is invalid and send access request 480 when the authentication information is valid.

Computing device 402 may refrain from presenting prompt 484 based on the contextual conditions 478 associated with access control devices 432. For example, contextual conditions 478A may require the user to be on foot while contextual conditions 478B may require the user to be on vehicular transport. As such, assuming computing device 402B determines the user is on vehicular transport, computing device 402B may present prompt 484 to user 482B and refrain from presenting prompt 484 even when computing device 402B may be in sufficient proximity to communicate with access control devices 432B and one or more of access control devices 432A, 432C.

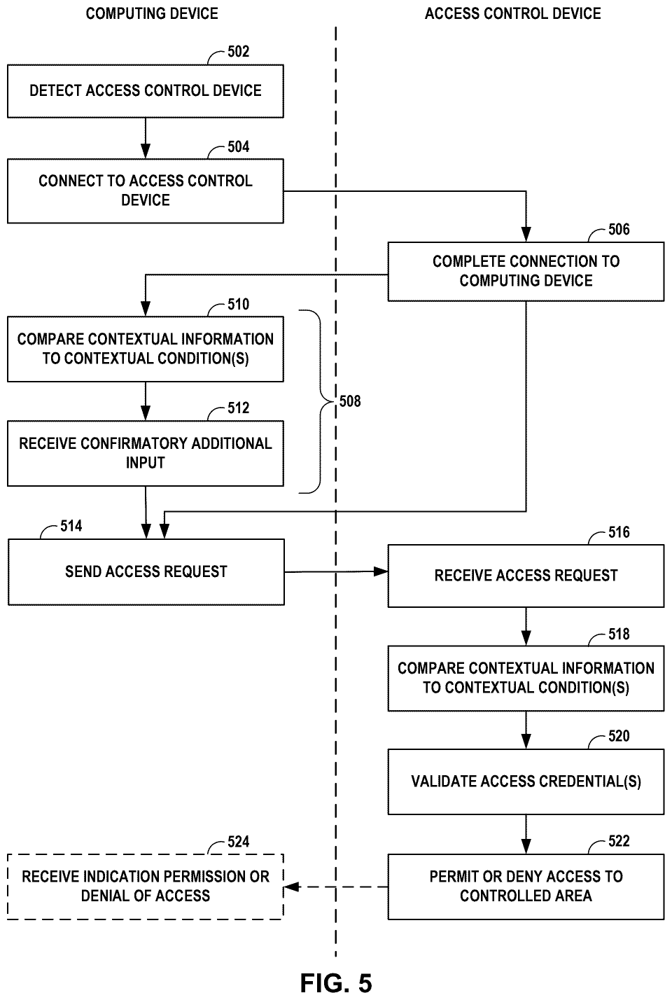

FIG. 5 is a conceptual diagram illustrating an example process for context-tagging access credentials for physical access control, in accordance with one or more aspects of the present disclosure. In the example of FIG. 5, a computing device (such as computing device 102 of FIG. 1) performs context-tagging access credentials for physical access control in conjunction with an access control device (such as access control device 132 of FIG. 1). FIG. 5 is described below in the context of FIG. 1.

Computing device 102 detects access control device 132 in proximity to computing device 102 (502). Computing device 102 may detect access control device 132 is in proximity (e.g., within a distance threshold) by scanning for access control device 132 using communication units 114 (e.g., WI-FI, BLUETOOTH, BLUETOOTH Low Energy radios), sensors 112 (e.g., ultra-wideband sensors), or both and attempting to establish a communication session with any access control device 132 within communication range of computing device 102.

Computing device 102 may connect to access control device (504) through direct connection 128 or network 126, such as by using one or more communication protocols such as WI-FI, BLUETOOTH, BLUETOOTH Low Energy, ultra-wideband, or other communication protocol. Access control device 132, such as in response to an initial communication (e.g., handshake) from computing device 102, may reciprocate by completing the establishment of the communication session with computing device 102 (506). For example, access control device 132 may complete the handshake process and thereby complete the connection to computing device 102.

In non-hands free situations, computing device 102 may perform prompting steps 508 and, in hands free situations, computing device 102 may not perform steps 508. Computing device 102 may distinguish hands free situations from non-hands free situations based on configuration settings. In some examples, computing device 102 may determine a hands free situation when computing device 102 and/or access control device 132 uses ultra-wideband for proximity detection and/or communication.

Assuming a non-hands free situation, computing device 102 may compare the contextual information of computing device 102 to the contextual conditions of access control device 132 (510). When the contextual information satisfies the contextual conditions, computing device 102 may receive a confirmatory additional input from the user (512), such as in response to computing device 102 presenting a prompt for the additional input to the user.

Computing device 102 may send an access request to access control device 132 (514) which access control device 132 may receive (516). As described above, the access request may include the contextual information and one or more access credentials. Though not shown, in a non-hands free situation, when the contextual information does not satisfy the contextual conditions or when no confirmatory additional input is received from the user, computing device 102 may refrain from sending an access request.

Access control device 132 may compare the contextual information of computing device 102 to the contextual conditions of access control device 132 (518). Access control device 132 may validate the access credentials (520). Access control device 132 may provide or deny access to controlled area 130 (522) based on the comparison of the contextual information to the contextual conditions and the validation of the access credentials. For example, access control device 132 may provide access to controlled area 130 when the contextual information satisfies the contextual conditions and the access credentials are valid. Access control device 132 may deny access to the controlled area 130 when the contextual information does not satisfy the contextual conditions or the access credentials are invalid. Access control device 132 may optionally send an indication of whether access control device 132 permits or denies access. Computing device 102 may receive such indication (524), such as for presentation to the user through output device 108.

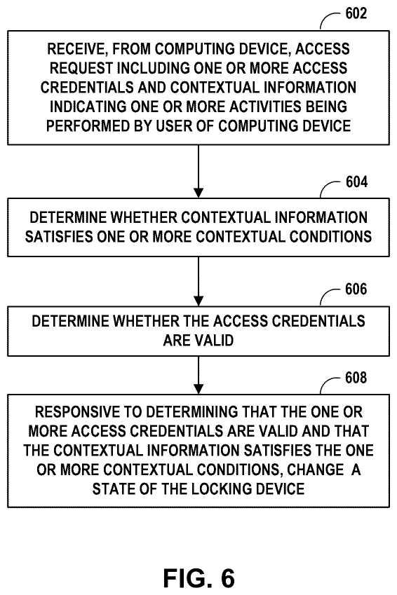

FIG. 6 is a flowchart of a first example process for context-tagging access credentials for physical access control, in accordance with one or more aspects of the present disclosure. FIG. 6 is described below in the context of FIG. 1.

Access control device 132 may receive an access request from computing device 102 (602). As described above, the access request may include one or more access credentials and contextual information indicating one or more activities being performed by a user of computing device 102. The contextual information may include one or more activity indicators. For example, the activity indicators may identify whether the user of computing device 102 is on foot or on a vehicular transport and/or whether the user of computing device 102 is inside or outside the controlled area. Access control device 132 may receive the contextual conditions, such as from computing system 120.

Access control device 132 may determine whether the contextual information satisfies one or more contextual conditions (604). Access control device 132 may compare the contextual information to the one or more contextual conditions to determine whether the contextual information satisfies one or more contextual conditions. For example, the contextual conditions and contextual information may each include one or more activity indicators (e.g., on foot, on vehicular transport, inside controlled area, outside controlled area). Access control device 132 may permit access when at least one of the activity indicator(s) of the contextual information corresponds to (e.g., match) each of the activity indicator(s) of the contextual conditions. Access control device 132 may not permit access to controlled area 130 unless the contextual information satisfies the contextual conditions.

Access control device 132 may determine whether the access credentials are valid (606). For example, access control device 132 may use validation information, which may be received from computing system 120, to determine whether the access credentials are valid. Access control device 132 may execute various matching or cryptographic processes (e.g., PKI) to validate the access credentials, such as described above. Responsive to determining that the one or more access credentials are valid and responsive to determining that the contextual information satisfies the one or more contextual conditions, access control device 132 may change a state of the locking device (608). For example, to change the state of the locking device, access control device 132 may unlock the locking device. Access control devices 132 may change the state of the locking device to an unlocked state such as when the contextual information satisfies the one or more contextual conditions. Access control device 132 may refrain from changing the state of the locking device when the contextual information does not satisfy the one or more contextual conditions. As described above, access control device 132 may not permit access to controlled area 130 unless the access credentials are valid.

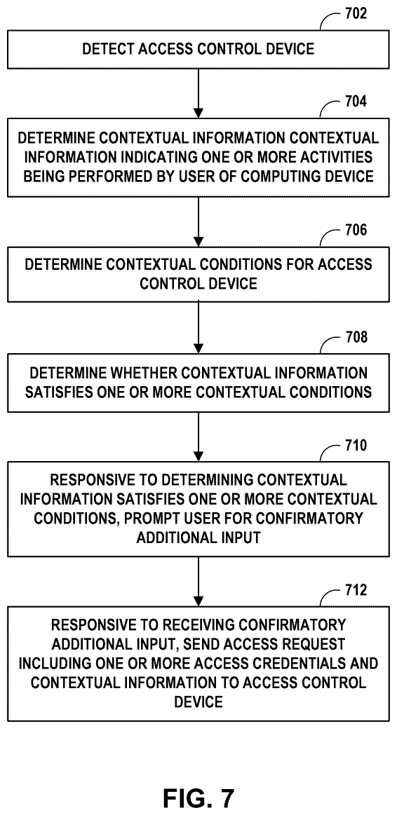

FIG. 7 is a flowchart of a second example process for context-tagging access credentials for physical access control, in accordance with one or more aspects of the present disclosure. FIG. 7 is described below in the context of FIG. 1.

Computing device 102 may detect access control device 132 (702). For example, computing device 102 may detect access control device 132 in proximity to computing device 102. Computing device 102 may detect access control device 132 is in proximity (e.g., within a distance threshold) by scanning for access control device 132 using communication units 114 (e.g., WI-FI, BLUETOOTH radios), sensors 112 (e.g., ultra-wideband sensors), or both and attempting to establish a communication session with any access control device 132 within communication range of computing device 102.

Computing device 102 may determine the contextual information indicating one or more activities being performed by the user of computing device 102 (704). Computing device 102 may determine the contextual information in various ways. In some examples, computing device 102 may obtain sensor information from one or more sensors 112 and generate the contextual information based on the sensor information. Computing device 102 may determine the contextual conditions for access control device 132 (706). For example, computing device 102 may request and receive the contextual conditions for access control device 132 from access control device 132, computing system 120, or both, such as through direct connection 128, network 126, or both. Computing device 102 may, in some examples, request the contextual conditions for access control device 132 by sending a request including an indication of access control device 132 (e.g., an identifier of access control device). In response, access control device 132 and/or computing system 120 may send the contextual conditions to computing device 102. In some examples, computing system 120 may send the contextual conditions to computing device 102 without a request (e.g., as part of the provisioning, pairing, or registration process for computing device 102).

Computing device 102 may determine whether the contextual information satisfies the contextual conditions (708), such as by comparing the contextual information to the contextual conditions as described above. Responsive to determining the contextual information satisfies the contextual conditions, computing device 102 may prompt the user of confirmatory addition input (e.g., confirmation or authorization) (710). In some examples, computing device 102 may present a prompt through an output device 108 and receive the confirmatory additional input through an input device 106.

Responsive to receiving the confirmatory additional input, computing device 102 may send, to access control device 132, an access request including one or more access credentials and the contextual information (712). Computing device 102 may refrain from sending the access credentials when the confirmatory additional input is not received from the user (e.g., the user provides non-confirmatory additional input or ignores the prompt). Access control device 132 may receive the access request and permit or deny access to controlled area 130, such as described in connection with FIG. 6.

This disclosure includes the following examples.

Example 1: A method includes receiving, by an access control device associated with a locking device for a controlled area and from a computing device, an access request including one or more access credentials and contextual information indicating one or more activities being performed by a user of the computing device, determining, by the access control device, whether the contextual information satisfies one or more contextual conditions, determining, by the access control device, whether the one or more access credentials are valid, and, responsive to determining that the one or more access credentials are valid and responsive to determining that the contextual information satisfies the one or more contextual conditions, changing, by the access control device, a state of the locking device.

Example 2: The method of example 1, wherein the contextual information includes one or more activity indicators.

Example 3: The method of example 2, wherein the one or more activity indicators identify whether the user of the computing device is on foot or on a vehicular transport.

Example 4: The method of example 2, wherein the one or more activity indicators identify whether the user of the computing device is inside or outside the controlled area.

Example 5: The method of any of examples 1-4, further comprising: receiving, by the access control device and during a provisioning process, the one or more contextual conditions; and storing, at a storage device of the access control device, the one or more contextual conditions, wherein determining whether the contextual information satisfies the one or more contextual conditions includes: retrieving, from the storage device, the one or more contextual conditions; comparing, by the access control device, at least one value from the contextual information to at least one value from the one or more contextual conditions; and determining, by the access control device, that the contextual information satisfies the one or more contextual conditions when the at least one value from the contextual information matches the at least one value from the one or more contextual conditions.

Example 6: The method of any of examples 1-5, wherein changing the state of the locking device comprises changing, by the access control device, the state of the locking device to an unlocked state in response to validating the one or more access credentials and determining that the contextual information satisfies the one or more contextual conditions.

Example 7: The method of any of examples 1-6, further comprising: responsive to determining that the one or more access credentials are not valid or responsive to determining that the contextual information does not the one or more contextual conditions, refraining, by the access control device, from changing the state of the locking device.

Example 8: The method of any of examples 1-7, wherein: the contextual information includes a Door_Type variable and a User_Activity variable; the Door_Type variable includes a type of a door associated with the locking device; and the User_Activity variable includes at least one type of user interaction.

Example 9: The method of example 8, wherein the Door_Type variable includes one or more of a pedestrian door, a garage door, a security door, a vault door, a turnstile, an automatic door, a revolving door, a sliding door, a gate, and a roll-up door, and wherein the User_Activity variable includes one or more of walking, running, cycling, driving, riding, skating, dancing, jumping, on foot, or on vehicular transport.

Example 10: The method of any of examples 1-9, wherein determining whether the contextual information satisfies the one or more contextual conditions comprises: sending, by the access control device and to a remote computing system, an indication of the contextual information; and receiving, by the access control device and from the remote computing system, an indication of whether the contextual information satisfies the one or more contextual conditions.

Example 11: The method of example 10, wherein determining whether the contextual information satisfies the one or more contextual conditions further comprises: sending, by the access control device and to the remote computing system, an indication of the one or more contextual conditions.

Example 12: A method comprising: receiving, by a computing system, provisioning information for an access control device, wherein the provisioning information includes a door type and one or more user activity types; storing, by the computing system, the provisioning information; and provisioning, by the computing system, the access control device using the provisioning information.

Example 13: A computing device includes a locking device for a controlled area; a memory that stores instructions; and processing circuitry that executes the instructions to: receive, from a computing device, an access request including one or more access credentials and contextual information indicating one or more activities being performed by a user of the computing device; determine whether the contextual information satisfies one or more contextual conditions; whether the one or more access credentials are valid; and, responsive to determining that the one or more access credentials are valid and responsive to determining that the contextual information satisfies the one or more contextual conditions, change a state of the locking device.

Example 14: The computing device of example 13, wherein the contextual information includes one or more activity indicators.

Example 15: The computing device of example 14, wherein the one or more activity indicators identify whether the user of the computing device is on foot or on a vehicular transport.

Example 16: The computing device of example 14, wherein the one or more activity indicators identify whether the user of the computing device is inside or outside the controlled area.

Example 17: The computing device of any of examples 13-16, wherein the processing circuitry further executes the instructions to: receive, during a provisioning process, the one or more contextual conditions; and store, at the memory, the one or more contextual conditions, wherein the processing circuiting determines whether the contextual information satisfies the one or more contextual conditions by at least executing the instructions to retrieve, from the memory, the one or more contextual conditions; compare at least one value from the contextual information to at least one value from the one or more contextual conditions; and determine that the contextual information satisfies the one or more contextual conditions when the at least one value from the contextual information matches the at least one value from the one or more contextual conditions.

Example 18: The computing device of any of examples 13-17, wherein to change the state of the locking device the processing circuitry executes the instructions to change the state of the locking device to an unlocked state in response to validating the one or more access credentials and determining that the contextual information satisfies the one or more contextual conditions.

Example 19: The computing device of any of examples 13-18, wherein the processing circuitry executes the instructions to, responsive to determining that the one or more access credentials are not valid or responsive to determining that the contextual information does not the one or more contextual conditions, refrain from changing the state of the locking device.

Example 20: The computing device of any of examples 13-19, wherein: the contextual information includes a Door_Type variable and a User_Activity variable; the Door_Type variable includes a type of a door associated with the locking device; and the User_Activity variable includes at least one type of user interaction.

Example 21: The computing device of example 20, wherein the Door_Type variable includes one or more of a pedestrian door, a garage door, a security door, a vault door, a turnstile, an automatic door, a revolving door, a sliding door, a gate, and a roll-up door, and wherein the User_Activity variable includes one or more of walking, running, cycling, driving, riding, skating, dancing, jumping, on foot, or on vehicular transport.

Example 22: The computing device of any of examples 13-21, wherein the processing circuitry determines whether the contextual information satisfies the one or more contextual conditions by at least executing the instructions to send, to a remote computing system, an indication of the contextual information; and receive, from the remote computing system, an indication of whether the contextual information satisfies the one or more contextual conditions.

Example 23: The computing device of example 22, wherein the processing circuitry determines whether the contextual information satisfies the one or more contextual conditions by at least executing the instructions to send, to a remote computing system, an indication of the one or more contextual conditions.

Example 24: A non-transitory computer-readable storage media storing instructions that, when executed by processing circuitry, cause the processing circuitry to: receive, from a computing device, an access request including one or more access credentials and contextual information indicating one or more activities being performed by a user of the computing device; determine whether the contextual information satisfies one or more contextual conditions; whether the one or more access credentials are valid; and, responsive to determining that the one or more access credentials are valid and responsive to determining that the contextual information satisfies the one or more contextual conditions, change a state of the locking device.

Example 25: The non-transitory computer-readable storage media of example 24, wherein the contextual information includes one or more activity indicators.

Example 26: The non-transitory computer-readable storage media of example 25, wherein the one or more activity indicators identify whether the user of the computing device is on foot or on a vehicular transport.

Example 27: The non-transitory computer-readable storage media of example 25, wherein the one or more activity indicators identify whether the user of the computing device is inside or outside a controlled area.

Example 28: The non-transitory computer-readable storage media of any of examples 24-27, wherein the processing circuitry further executes the instructions to: receive, during a provisioning process, the one or more contextual conditions; and store, at the memory, the one or more contextual conditions, wherein the processing circuiting determines whether the contextual information satisfies the one or more contextual conditions by at least executing the instructions to retrieve, from the memory, the one or more contextual conditions; compare at least one value from the contextual information to at least one value from the one or more contextual conditions; and determine that the contextual information satisfies the one or more contextual conditions when the at least one value from the contextual information matches the at least one value from the one or more contextual conditions.

Example 29: The non-transitory computer-readable storage media of any of examples 24-28, wherein to change the state of the locking device the processing circuitry executes the instructions to change the state of the locking device to an unlocked state in response to validating the one or more access credentials and determining that the contextual information satisfies the one or more contextual conditions.

Example 30: The non-transitory computer-readable storage media of any of examples 24-29, wherein the processing circuitry executes the instructions to, responsive to determining that the one or more access credentials are not valid or responsive to determining that the contextual information does not the one or more contextual conditions, refrain from changing the state of the locking device.

Example 31: The non-transitory computer-readable storage media of any of examples 24-30, wherein: the contextual information includes a Door_Type variable and a User_Activity variable; the Door_Type variable includes a type of a door associated with the locking device; and the User_Activity variable includes at least one type of user interaction.

Example 32: The non-transitory computer-readable storage media of example 31, wherein the Door_Type variable includes one or more of a pedestrian door, a garage door, a security door, a vault door, a turnstile, an automatic door, a revolving door, a sliding door, a gate, and a roll-up door, and wherein the User_Activity variable includes one or more of walking, running, cycling, driving, riding, skating, dancing, jumping, on foot, or on vehicular transport.

Example 34: The non-transitory computer-readable storage media of any of examples 24-33, wherein the processing circuitry determines whether the contextual information satisfies the one or more contextual conditions by at least executing the instructions to send, to a remote computing system, an indication of the contextual information; and receive, from the remote computing system, an indication of whether the contextual information satisfies the one or more contextual conditions.

Example 35: The non-transitory computer-readable storage media of example 34, wherein the processing circuitry determines whether the contextual information satisfies the one or more contextual conditions by at least executing the instructions to send, to a remote computing system, an indication of the one or more contextual conditions.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the embodiment, certain acts or events of any of the methods described herein may be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, by an access control device associated with a locking device for a controlled area and from a computing device, an access request including one or more access credentials and contextual information indicating one or more activities being performed by a user of the computing device;
determining, by the access control device, whether the contextual information satisfies one or more contextual conditions;
determining, by the access control device, whether the one or more access credentials are valid; and
responsive to determining that the one or more access credentials are valid and responsive to determining that the contextual information satisfies the one or more contextual conditions, changing, by the access control device, a state of the locking device.

2. The method of claim 1, wherein the contextual information includes one or more activity indicators.

3. The method of claim 2, wherein the one or more activity indicators identify whether the user of the computing device is on foot or on a vehicular transport.

4. The method of claim 2, wherein the one or more activity indicators identify whether the user of the computing device is inside or outside the controlled area.

5. The method of claim 1, further comprising:
receiving, by the access control device and during a provisioning process, the one or more contextual conditions; and
storing, at a storage device of the access control device, the one or more contextual conditions,
wherein determining whether the contextual information satisfies the one or more contextual conditions includes:
retrieving, from the storage device, the one or more contextual conditions;
comparing, by the access control device, at least one value from the contextual information to at least one value from the one or more contextual conditions; and
determining, by the access control device, that the contextual information satisfies the one or more contextual conditions when the at least one value from the contextual information matches the at least one value from the one or more contextual conditions.

6. The method of claim 1, wherein changing the state of the locking device comprises changing, by the access control device, the state of the locking device to an unlocked state in response to validating the one or more access credentials and determining that the contextual information satisfies the one or more contextual conditions.

7. The method of claim 1, further comprising:
responsive to determining that the one or more access credentials are not valid or responsive to determining that the contextual information does not the one or more contextual conditions, refraining, by the access control device, from changing the state of the locking device.

8. The method of claim 1, wherein:
the contextual information includes a Door_Type variable and a User_Activity variable;
the Door_Type variable includes a type of a door associated with the locking device; and
the User_Activity variable includes at least one type of user interaction.

9. The method of claim 8,
wherein the Door_Type variable includes one or more of a pedestrian door, a garage door, a security door, a vault door, a turnstile, an automatic door, a revolving door, a sliding door, a gate, and a roll-up door, and
wherein the User_Activity variable includes one or more of walking, running, cycling, driving, riding, skating, dancing, jumping, on foot, or on vehicular transport.

10. The method of claim 1, wherein determining whether the contextual information satisfies the one or more contextual conditions comprises:
sending, by the access control device and to a remote computing system, an indication of the contextual information; and
receiving, by the access control device and from the remote computing system, an indication of whether the contextual information satisfies the one or more contextual conditions.

11. The method of claim 10, wherein determining whether the contextual information satisfies the one or more contextual conditions further comprises:
sending, by the access control device and to the remote computing system, an indication of the one or more contextual conditions.

12. A method comprising:
receiving, by a computing system, provisioning information for an access control device, wherein the provisioning information includes a door type and one or more user activity types;
storing, by the computing system, the provisioning information; and
provisioning, by the computing system, the access control device using the provisioning information.

13. A computing device comprising:
a locking device for a controlled area;
a memory that stores instructions; and processing circuitry that executes the instructions to:
receive, from a computing device, an access request including one or more access credentials and contextual information indicating one or more activities being performed by a user of the computing device;
determine whether the contextual information satisfies one or more contextual conditions; whether the one or more access credentials are valid; and
responsive to determining that the one or more access credentials are valid and responsive to determining that the contextual information satisfies the one or more contextual conditions, change a state of the locking device.

14. The computing device of claim 13, wherein the contextual information includes one or more activity indicators.

15. The computing device of claim 13, wherein the processing circuitry further executes the instructions to:
receive, during a provisioning process, the one or more contextual conditions; and
store, at the memory, the one or more contextual conditions,
wherein the processing circuiting determines whether the contextual information satisfies the one or more contextual conditions by at least executing the instructions to:
retrieve, from the memory, the one or more contextual conditions;
compare at least one value from the contextual information to at least one value from the one or more contextual conditions; and
determine that the contextual information satisfies the one or more contextual conditions when the at least one value from the contextual information matches the at least one value from the one or more contextual conditions.

16. The computing device of claim 13, wherein to change the state of the locking device the processing circuitry executes the instructions to change the state of the locking device to an unlocked state in response to validating the one or more access credentials and determining that the contextual information satisfies the one or more contextual conditions.

17. The computing device of claim 13, wherein:
the contextual information includes a Door_Type variable and a User_Activity variable;
the Door_Type variable includes a type of a door associated with the locking device; and
the User_Activity variable includes at least one type of user interaction.

18. The computing device of claim 17, wherein the Door_Type variable includes one or more of a pedestrian door, a garage door, a security door, a vault door, a turnstile, an automatic door, a revolving door, a sliding door, a gate, and a roll-up door, and wherein the User_Activity variable includes one or more of walking, running, cycling, driving, riding, skating, dancing, jumping, on foot, or on vehicular transport.

19. The computing device of claim 13, wherein the processing circuitry determines whether the contextual information satisfies the one or more contextual conditions by at least executing the instructions to:
send, to a remote computing system, an indication of the contextual information; and
receive, from the remote computing system, an indication of whether the contextual information satisfies the one or more contextual conditions.

20. A non-transitory computer-readable storage media storing instructions that, when executed by processing circuitry of an access control device associated with a locking device for a controlled area, cause the processing circuitry to:
receive, from a computing device, an access request including one or more access credentials and contextual information indicating one or more activities being performed by a user of the computing device;
determine whether the contextual information satisfies one or more contextual conditions; whether the one or more access credentials are valid; and
responsive to determining that the one or more access credentials are valid and responsive to determining that the contextual information satisfies the one or more contextual conditions, change a state of the locking device.
